(19) United States
(12) Patent Application Publication
(10) Pub. No.: US 2022/0049541 A1
(43) Pub. Date: Feb. 17, 2022

(54) LOW-COST HIGH-PERFORMANCE VACUUM INSULATED GLASS AND METHOD OF FABRICATION

(71) Applicant: UNIVERSITY OF MARYLAND, COLLEGE PARK, College Park, MD (US)

(72) Inventors: Jungho KIM, ROCKVILLE, MD (US); Ratnesh TIWARI, HYATTSVILLE, MD (US)

(21) Appl. No.: 17/292,233

(22) PCT Filed: Nov. 8, 2019
(86) PCT No.: PCT/US2019/060471

§ 371 Date: May 7, 2021

Related U.S. Application Data
(60) Provisional application No. 62/758,287, filed on Nov. 9, 2018.

(51) Int. Cl. E06B 3/663; E06B 3/66; E06B 3/67; E06B 3/673; E06B 3/677; B32B 7/14; B32B 5/02; B32B 17/06; B32B 37/06; B32B 3/12

(52) U.S. Cl. CPC E06B 3/66304; B32B 2307/304; E06B 3/6715; E06B 3/67326; E06B 3/677; B32B 7/14; B32B 5/028; B32B 17/067; B32B 37/06; B32B 3/12; B32B 2262/101; B32B 2262/103; B32B 2262/105; B32B 2255/00; B32B 2307/732; B32B 2309/68; B32B 2419/00; E06B 3/6612

(57) ABSTRACT

A low-cost high-performance Vacuum Insulated Glass is produced with three glass panes and bonding fiber mesh structures embedded between the glass panes. Each mesh structure is configured with elongated bonding fiber elements arranged in a grid configuration. The bonding fiber elements are formed with a fiber core covered with a low melting temperature material. The low melting temperature material melts upon heating and creates numerous vacuum sealed cells between the glass panes. The fiber core does not melt, and remains intact bonded to the glass panes, thus creating a support mechanism for supporting the glass panes at a spaced apart relationship.

### REFERENCE TO RELATED PATENT APPLICATIONS

This Utility Patent Application a National Stage of PCT Application PCT/US2019/060471 filed 8 Nov. 2019, which is based on a Provisional Patent Application Ser. No. 62/758,287 filed 9 Nov. 2018.

### FIELD OF THE INVENTION

The present invention is directed to a low-cost high-performance vacuum insulated glass (VIG), and in particular, to vacuum insulated glass which may be used as a window glass.

The present invention is further directed to high-performance vacuum insulated glass which uses a fiber bonding technology to create a vacuum insulated glass which can be cut to a selected size while maintaining the vacuum.

The subject invention also addresses a vacuum insulated glass which supports a multi-layered glass structure with numerous vacuum sealed cells formed between the layers where the vacuum is maintained in majority of the cells even after the multi-layered glass structure is cut to a required size.

In addition, the present invention is directed to the vacuum insulated glass which is configured with a plurality of glass panes, and includes fibers coated with a low melting temperature material arranged in a grid pattern and embedded between the glass panes. The low melting temperature material provides a bonding (sealing) function, while the fibers provide glass panes supporting (separating) function.

In certain embodiments, the present invention is directed to a vacuum insulated glass suitable as a low-cost installation window glass for a direct replacement of a single pane window without replacing the window sash.

The present invention is also directed to a high-performance vacuum insulated glass which can be manufactured in a mass production fashion and offers superior sound insulation. Additionally, the vacuum insulated glass delivers an estimated overall U factor (a measure of the rate of heat transfer through the glass which also reflects the insulation quality of the glass) in the range of 0.2 to 0.5 W/m²-K, condensation temperature below −20° C., and provides flexibility in cutting and sizing.

In addition, the present invention is directed to a high-performance vacuum insulated glass which includes at least three glass panes (glass layers) stacked one to another with a vacuum gap defined between adjacent glass panes where a fiber covered with a low melting temperature bonding (sealing) material is arranged in a grid-like (mesh) configuration and is embedded within the gap between the glass panes. The mesh configuration defines a network of cells, each outlined by the fibers/bonding material. Upon melting and subsequent solidification, the bonding material seals each cell at its periphery, so that after the manufactured vacuum insulated glass is cut to a required size, numerous vacuum sealed cells remain intact which hold the vacuum, thus maintaining vacuum in the vacuum insulated glass.

The present invention furthermore is directed to a high-performance vacuum insulated glass which is configured with a multiplicity of glass panes stacked one to another with the bonding fiber mesh embedded therebetween, where the bonding fiber mesh can be pre-fabricated in rolls, or can be configured between the glass layers (panes) in a predetermined fashion, for example, by 3-D printing or silk screening, to form a plurality of hermetically sealed cells, each cell outlined at its periphery by the bonding fiber elements.

Moreover, the present invention is directed to a high-performance vacuum insulated glass which includes multiple glass panes and fibers covered by the bonding (sealing) material embedded between the glass panes which are subsequently bonded in a vacuum environment along the fiber bonding material to produce numerous hermetically sealed cells between each two glass panes, thus fabricating, in a highly efficient manner, a low-cost vacuum insulated glass without an additional evacuation step required for the traditional fabrication of the vacuum insulated glass.

The present invention is also directed to a highly efficient and economical manufacturing process for production of high-performance low-cost vacuum insulated glass which includes numerous evacuated cells, each sealed at its periphery by the fiber bonding material. Thus the produced subject glass when cut to a required size, permits most of the cells to remain evacuated. Only the cells in proximity to the cut edge lose vacuum.

The present invention is further directed to a high-performance vacuum insulated glass where preferably a minimum of three glass panes are used for a window, where the heat transfer through the window is minimized due to the heat conduction across the fibers embedded between the adjacent panes, and where two triple pane window structures may be used to replace a single standard double-pane insulated glass unit (IGU) and provide much higher insulation with the R-value (the measure of the resistance of the glazing to heat flow) reaching up to R=5.4 m²-K/W.

The present invention is also directed to a high performance vacuum insulated glass which may be used in hybrid windows in which one of the glass panes in the traditional double pane IGU may be replaced by the high performance triple pane vacuum insulated glass (TPVIG) which greatly increase the insulating quality of the entire window.

### BACKGROUND OF THE INVENTION

Heat loss through windows during cold weather in North America consumes approximately 3.9 quads of primary energy. Single pane windows comprise approximately 30% of the existing window stock, and account for approximately 2.0 quads of the primary energy loss.

An optimal retrofit solution to replace an existing single pane window would provide (a) Capability of direct replacement of the existing window pane, i.e., it can be installed in the same way a single pane window is replaced. The direct replacement approach should permit the cutting of a large sheet of window pane to a desired size, and installation of the cut-down glass pane into the existing window sash; (b) The retrofit window should have a minimum U value and be resistant to the condensation; (c) The retrofit window must be reliable for the life of the window; (d) The retrofit window is to be optically clear; and, (e) The retrofit window should have a low thickness of the glazing.

The current major option for the replacement of the single pane windows is an insulated glazing (IGU), or a double pane glazing, which are double pane glazing units filled with low thermal conductivity gases acting as insulators.

IGUs have satisfactory thermal performance, sound proofing and condensation resistance. However, they do not qualify as a direct retrofit, since IGUs require the replacement of the existing frame (sash), thus resulting in high installation cost, and can be structurally challenging on the building wall. Apart from that, the IGUs are custom made in size, unlike the single pane windows, and thus have high initial fabrication costs. These combined issues for the most part have prevented the replacement of single pane windows with the double pane windows.

State of the art Vacuum Insulated Glasses (VIGs), such as, for example, Pilkington Spacia, are superior to the IGUs in the heat transfer and soundproofing, but are even more expensive than IGUs and, hence, are less attractive from economic point of view. The dominant technology for window glass currently is the double pane window with a gap formed between the glass panes which is filled with an inert gas.

A vacuum between the panes instead of argon would be a preferred solution. Since the gap between the glass panes does not affect the performance of the glazing, even a very thin gap equivalent to the size of a human hair would be sufficient to create the thermal barrier under sufficient vacuum.

The vacuum insulated glass (VIGs) windows may be very thin (5-10 mm in thickness), and low weight, making them suitable for retrofitting single pane windows.

The manufacturing process for Pilkington Spacia (shown in FIG. 1) involves several steps, such as: (a) custom cutting of the glass panes, usually 3 mm thick glass sheets) (b) placement of support pillars (˜0.5 mm in diameter) between two glass panes followed by peripheral sealing (welded edges) of the glasses. A typical window is sealed at the periphery using metallic or glass frit bonding. Very minute size spacers (support pillars) are placed using robotic arms at about 20-45 mm spacing to hold the glasses apart when under vacuum, (c) drilling a hole (vacuum implementation port) in one of the glass panes to insert a suction pin/valve, (d) vacuum creation through the suction pin/valve, and (e) sealing the suction valve after the vacuum is created. Each Pilkington Spacia window is custom made, i.e., is manufactured one at a time, and thus, the process results in a prohibitively high manufacturing cost. A third pane is usually required to withstand the excessive thermal and/or wind related stresses to improve the reliability of the overall glass structure in very cold climates.

Apart from cost concerns, the seal reliability, due to the glass vibration and thermally induced stress, affects the lifespan of the windows. In addition, the conventional VIGs are not suitable as a replacement for existing single-pane windows without changing the sash, since the VIGs cannot be cut to a size without losing vacuum between the glass panes. These shortcomings have prevented widespread use of traditional VIGs.

VIG manufacturers do not recommend VIGs to be used in cold climates where the temperature difference between the indoor and outdoor temperature exceeds 35° C. Also, due to the protruding vacuum suction valve, the VIG units cannot be shipped like single pane units and need special packaging to avoid the breakage. The protruding valve also hinders the cleaning of the glass pane and hinders the visible area of the glass.

It would be highly desirable to find a window glass solution which would have superior performance to reduce energy consumption, yet enjoy lower installation cost to transform the market.

### SUMMARY OF THE INVENTION

It is therefore an object of the present invention to provide a low-cost vacuum insulated glass (VIG) which is mass produced, can be cut to a desired size without losing vacuum in a majority glass, and which can be used as a low-cost installation retrofit for the existing single pane windows without changing the window frames (sash).

It is another object of the present invention to provide a vacuum insulated glass comprised of numerous (at least three) glass panes separated one from another by vacuumed gaps containing bonding fiber structure (formed with a fiber core covered with bonding (sealing) material) embedded in the gaps which act as a support (separation) structure to prevent the glass panes from touching each other, as well as a bonding (sealing) structure preventing vacuum between the glass panes.

It is a further object of the present invention to provide a vacuum insulated glass which offers increased reliability obtained by distributing the stresses thereby reducing stress concentrations, with a reduced vacuum leakage due to damage incurred during the lifetime of the window.

It is still an object of the present invention to provide a vacuum insulated glass which includes numerous small vacuum sealed cells formed between each two adjacent glass panes which permit the VIG block to be cut to any required size for the retrofit purposes without losing the vacuum in the majority of cells in the VIG block.

An additional object of the present invention is to provide a triple pane glass vacuum insulated glass (TPVIG) using three glass panels of the thickness of 1.5 mm-3.5 mm, separated by ˜0.15 mm gaps containing a mesh structure formed with a glass fiber core coated with a low melting temperature glass powder (frit) embedded between the glass panes and fused to create multiple sealed vacuum cells between the glass panes where each vacuum sealed cell is sealed at its periphery by the elongated elements of glass fiber mesh, particularly, the low melting temperature glass portion.

It is another object of the present invention to provide a vacuum insulated glass comprised of numerous (at least three) glass panes separated one from another by respective vacuumed gaps embedded with fibers covered with bonding material which act as a support (separation) mechanism to prevent the glass panes from touching each other, as well as a bonding (sealing) mechanism preventing loss of vacuum between the glass panes.

It is a further object of the present invention to provide a manufacturing process for fabrication of high-performance low-cost vacuum insulated glass which does not require the installation of the conventional support pillars provided in the traditional VIG. Instead, the subject vacuum insulated glass has a spacing/support mechanism implemented with a glass fiber mesh coated with a bonding material which creates multiple hermetically sealed vacuum cells inside the glazing, where the fiber acts as a support structure spacing the glass panes one from another, while the bonding (sealing) material melts to seal the vacuum cells upon its solidification, thus acting as a sealing structure, and bonds the glass panes each to the other. In the subject fabrication process, the bonding process is performed in a vacuum environment to avoid the expensive manual installation of the vacuum suction pin (or valve) customary for the traditional process.

In addition, an object of the subject invention is to manufacture a standard glass pane sized VIGs (e.g., 1.5 m×3.5 m) which can be subsequently cut for retrofitting purposes to a required size by glazing installers, thus eliminating the need for custom made insulated glass units for each replacement window size as is common in the conventional window retrofitting. Since no additional handling is needed during the subject fabrication process, the glass panes and bonding fiber mesh structure can be made in layers, and the stack of several VIGs can be produced in a single batch which further reduces the manufacturing costs.

It is a still further object of the present invention to develop a Triple-Pane Vacuum Insulated Glass (TPVIGs) with superior performance yet having much lower installation cost than traditional IGUs. Unique features of the subject TPVIG include providing cutting of a glass to a required size without losing vacuum as well as mass production approaches (no need for custom manufacturing) of the windows, that makes the subject VIG highly economically attractive. Since the subject TPVIG can be mass produced, its production cost is similar to, or lower than, that of the IGUs while performance characteristics exceed those of the conventional window glasses. The subject TPVIG is thin, lightweight, has an excellent acoustic performance, and can fit in an existing single pane sash, thus minimizing installation cost.

Due to its thin and light weight construction, the subject TPVIG might not require a sash replacement for a single pane window replacement making it highly attractive for the single pane retrofit. Existing IGUs can also be replaced with superior performing and inexpensive TPVIGs.

It is still an object of the present invention to provide TPVIGs which do not require custom manufacturing of each window, but may be produced in standard size glass panes in a batch process where numerous glass panes are manufactured in a single vacuum chamber.

In one aspect, the present invention is a low-cost high-performance Vacuum Insulated Glass (VIG) which comprises at least a first glass pane and at least a second glass pane stacked relative to the first glass pane in a spaced apart relationship therewith, thus defining at least one gap therebetween. A sealing mechanism and a support mechanism is embedded in the gap defined between the first and second glass panes.

In a preferred embodiment, the sealing (also referred to herein as a bonding) mechanism includes at least a first plurality and at least a second plurality of elongated sealing (bonding) elements extending in crossing relationship substantially and continuously within the gap between the first and second glass panes. The support mechanism includes a first and second pluralities of elongated fiber elements extending in crossing relationship and in conjunction with the sealing (bonding) elements between the first and second glass panes. The sealing (bonding) elements as well as fiber elements (in combination referred to herein as bonding fiber elements) form a mesh structure embedded in the gap between the first and second glass panes, which bonds the first and second glass panes together along the elongated sealing elements, and supports the first and second glass panes at a predetermined separation distance one from another by the fibers overlapping each other at the crossing points.

The mesh structure, specifically, the sealing elements thereof, define a plurality of vacuum insulated (sealed) cells formed between the first and second glass panes, where each vacuum insulated cell is sealed along a periphery thereof by respective portions of the elongated sealing elements crossing each other at respective crossing points.

Specifically, the subject Triple Pane Vacuum Insulated Glass (TPVIG) may include a bottom glass pane, a top glass pane, and a middle glass pane sandwiched between the bottom and top glass panes, wherein a first gap is defined between the bottom and middle glass panes, and a second gap is defined between the middle and top glass panes.

A first mesh structure is embedded in the first gap to secure the bottom and middle glass panes at a first predetermined distance one from another, and to form a first plurality of vacuum sealed cells therebetween. A second mesh structure is embedded in the second gap to secure the middle and top glass panes at a second predetermined distance one from another, and to form a second plurality of vacuum sealed cells therebetween.

The sealing elements may be formed from a material such as a frit, (mixture of silica and fluxes), low melting temperature glass, low melting temperature metal, glass solder paste, and combinations thereof.

The fiber elements may be made from a glass, metal, ceramic, and the combination, which have a higher melting temperature, for example, exceeding ˜600° C.

In a preferred embodiment, the fiber elements are coated with a low melting temperature glass or metal. The mesh structures may be made with a single material, or from a combination of two or more materials.

The diameter of the fiber core may be about 75 μm, while the coating on the fiber core may be about 50 μm thick.

The glass panes generally may be of substantially the same thickness, but may have different thicknesses. One (or more) of the surfaces of one (or more) of the glass panes may be covered by a low emittance (low-e) coating which enhances the glass insulation performance by reducing the window emittance of infrared (IR) or ultra-violet (UV) radiation. Similarly, the first predetermined distance between the bottom and middle glass panes and the second predetermined distance between the middle and top glass panes may generally be substantially the same, but may be different as well.

In the subject Vacuum Insulated Glass, the first bonding fiber elements cross the second bonding fiber elements at a predetermined angular relationship which may range from 30° to 120°, thus contouring the vacuum sealed cells to assume a shape selected from a group including square, rectangle, triangle, rhombus, diamond, arcuated periphery, wavy periphery, and their combinations.

The first and second mesh structures embedded in the first and second gaps, respectively, may be aligned one with another, or be displaced one from another.

In another aspect, the present invention constitutes a method for fabrication of low-cost high-performance Vacuum Insulated Glass (VIG), by the steps of:
(a) manufacturing a first, a second, and a third glass panes,
(b) configuring a first mesh structure formed by first and second bonding (plurality of sealing) elements continually extending and crossing each other on a surface of the first glass pane at first respective crossing points, and first and second plurality of fiber elements extending in crossing relationship one with another along the sealing elements;
(c) positioning the second glass pane atop the first mesh structure on the first glass pane, in a first spaced apart relationship therewith, defined by combined diameters of the first and second fiber elements of said pluralities thereof overlapping at the first respective crossing points;
(d) configuring a second mesh structure formed by third and fourth bonding (pluralities of sealing) elements extending continually and crossing each other at second respective crossing points on a surface of the second glass pane facing away from the first glass pane, and third and fourth pluralities of fiber elements crossing each other on the surface of the second glass pane at the second crossing points;
(e) positioning the third glass pane on the second mesh structure on the second glass pane in a second spaced apart relationship therewith, thus forming a stacked assembly of the first, second, and third glass panes;
(f) introducing the stacked assembly in a vacuum chamber;
(g) creating a vacuum in the vacuum chamber;
(h) heating the stacked assembly in the vacuum chamber to a predetermined temperature, thus melting the bonding elements of the first and second mesh structures between the first, second and third glass panes, and forming a first and second plurality of vacuum sealed cells defined between the first and second glass panes, and between the second and third glass panes, respectively. Each of the vacuum sealed cells is sealed along the periphery thereof by respective portions of respective of the first, second, third and fourth (sealing) bonding elements, respectively.

The subject method further comprises:
embedding a first support mechanism in the first gap between the first and second glass panes, and
embedding a second support mechanism in the second gap between the second and third glass panes.

The first support mechanism includes the first and second plurality of fiber elements arranged substantially in alignment with the sealing elements of the first mesh structure, and the second support mechanism includes a third and fourth plurality of fiber elements arranged substantially in alignment with the sealing elements of the second mesh structure.

The first and second support mechanisms secure the first, second, and third glass panes in a predetermined spaced apart relationship one to another.

The application of the mesh structures of the respective surfaces of the respective glass panes may be administered in a variety of manners. For example, the mesh can be formed prior to the subject process in rolls of bonding fiber secured in a grid-like configuration, and applied to the glass panes. Alternatively, the bonding fiber may be formed as a fiber core covered with a jacket of the low melting temperature material by pulling the fiber core by a wire-coating (extrusion) procedure, or other suitable fiber coating process common in the opto-electronic production industry. The bonding fiber application also can be performed by 3-D printing, or screen printing, etc.

Low-e material may be applied to respective surface(s) of one (or more) glass pane(s) for enhancing optical and thermal insulation properties before or after the mesh is attached.

These and other objects and advantages of the subject invention will become more apparent from the Detailed Description of the Preferred Embodiment(s) of the Present Invention in conjunction with accompanying Patent Drawings.

### BRIEF DESCRIPTION OF THE DRAWINGS

FIG. 1 is a schematic representation of the prior art Vacuum Insulated Glass;

FIG. 2 is a schematic representation of the subject triple pane glass with numerous hermetically sealed cells;

FIG. 3 is a cross-section of the subject triple pane glass structure shown in FIG. 2;

FIG. 4 is representative of the bonding fiber element which is arranged in a grid configuration and embedded between the glass panes as best shown in FIG. 3;

FIG. 5 shows schematically the subject TPVIG with edge seals;

FIGS. 6A-6G show schematically the manufacturing process of the subject TPVIG, where FIG. 6F shows schematically a number of TPVIG assemblies with interspersed heaters in a vacuum chamber for the subject manufacturing process;

FIG. 7 shows the geometry of the subject glass pane; and

FIG. 8 is representative of the thermal analysis of the subject triple pane VIG.

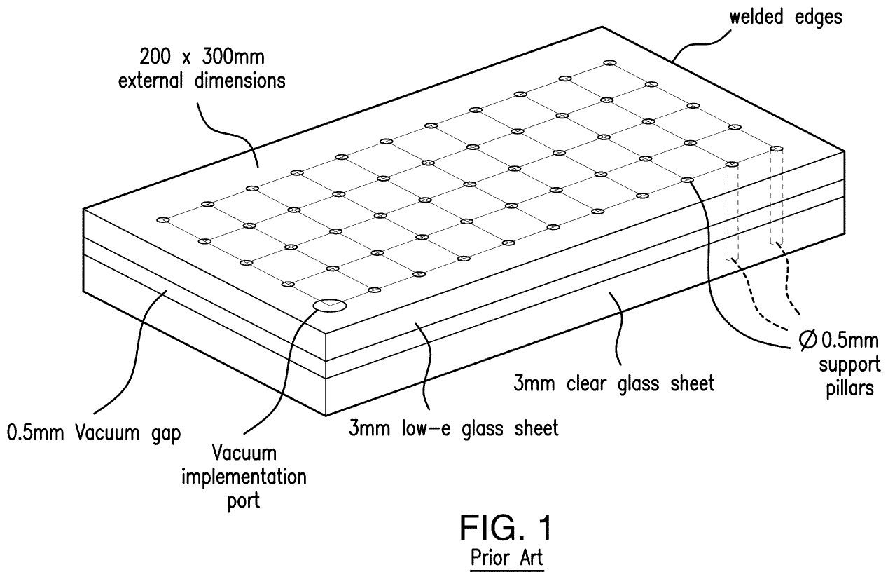

### DETAILED DESCRIPTION OF THE PREFERRED EMBODIMENT

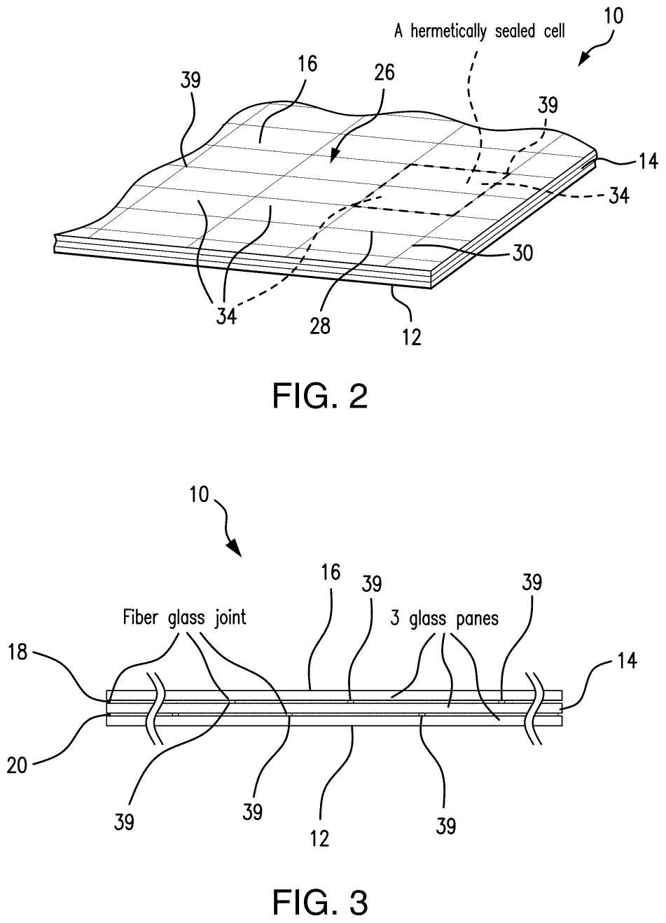

Referring to FIGS. 2-5, the subject triple pane vacuum insulated glass (TPVIG) 10 is made of two or more glass layers, i.e., glass panes. As an example, the subject VIG will be described herein as a triple pane glass using three glass panes, i.e., a bottom glass pane 12, a middle glass pane 14, and top glass pane 16 separated by small vacuum gaps which may typically range between 0.1 mm to 1 mm. The gap 20 is formed between the bottom glass pane 12 and the middle glass pane 14, and the gap 18 is formed between the middle glass pane 14 and the top glass pane 16.

The glass panes 12, 14, 16 may be of the same thickness or of a varying thickness, for example, selected from a range of 0.5 mm to 8 mm, preferably, from 1.5 mm to 3.5 mm, and even more preferably, from 1 mm to 2 mm. Similarly, the gaps 18, 20 may be of the same width (˜01 mm to ˜0.15 mm), or differ in their width.

In one embodiment, the gaps 18, 20 may be embedded with bonding fiber elements 21 arranged in grid-like (or mesh) structure 26.

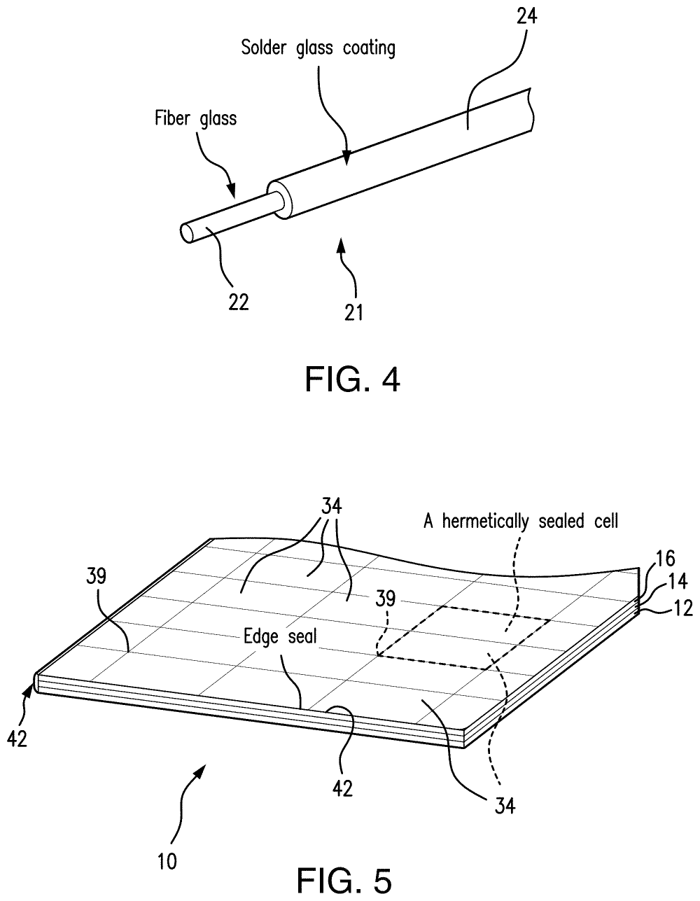

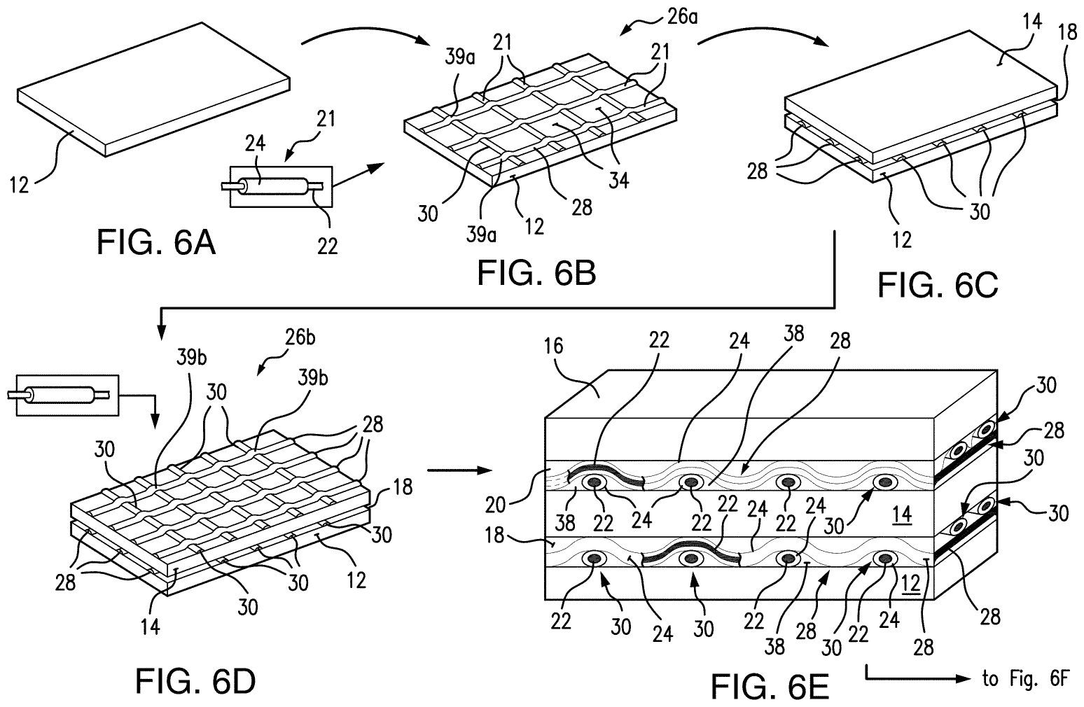

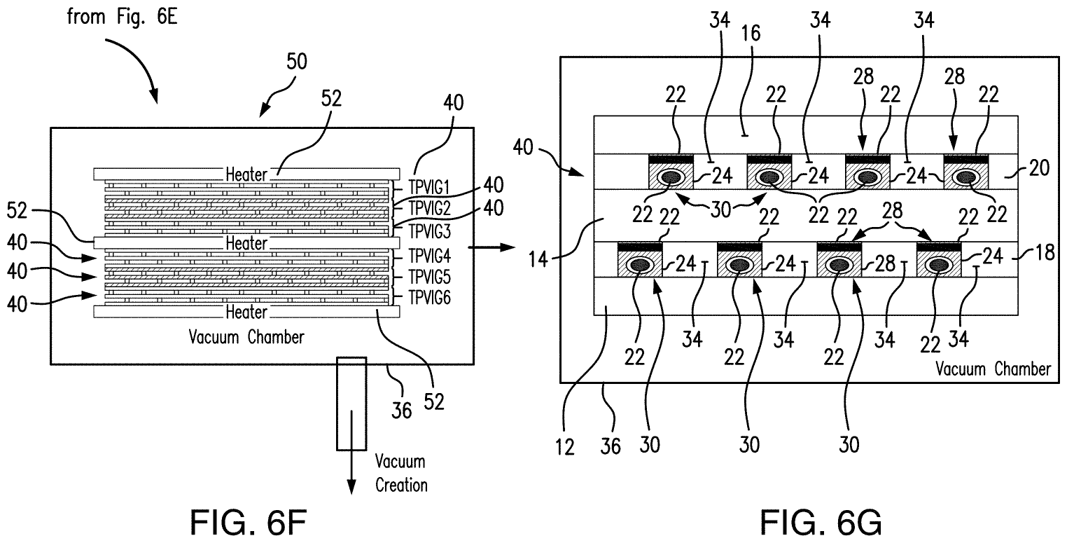

The bonding fiber element 21 includes a bonding fiber element 22 coated with low melting temperature material 24, as shown in FIGS. 4, 6F, and 6G. The low melting temperature material 24 melts at temperatures, for example, between 250° C.-500° C. The bonding fiber is placed between the glass panes 12, 14, 16 in the mesh configuration 26, which includes a plurality 28, 30 of the bonding fiber elements 21 extending substantially continually and crossing each other at respective crossing points 39, as shown in FIGS. 2, 3, 5, 6B, and 6D.

The crossing bonding fibers 28, 30 are arranged in a staggered array, and may extend at various angles therebetween. For example, the angle between the bonding fibers 28, 30 may range between 30° and 120°, as preferred by the design.

The crossing bonding fibers 28, 30 form cells 34 therebetween, so that each cell (which is vacuum sealed as will be presented infra herein) is outlined and is sealed with respective portions of the bonding element 24 of the crossing bonding fibers 28, 30.

For example, when the angle between bonding fibers 21 of the crossing pluralities 28, 30 thereof is 90°, the mesh structure 26 forms a plurality of cells 34 of a square or rectangular configuration. For angles less than 90°, the cells 34 may be of triangular configuration. Other angular variations may form cells of other shapes, such as for example, rhomboid, diamond, etc. configurations.

The mesh structures 26 in the gaps 18, 20 between each pair of the panes may be aligned with or offset from each other. The offset arrangement provides additional thermal resistance as the heat in this arrangement is forced to travel over a longer path within the middle glass pane 14. The arrangement with the aligned mesh structures, where fibers vertically overlap with each other, is beneficial as it provides reduced stress in the glass panes. However, this arrangement creates a thermal short between the panes 12, 14, 16, thus resulting in a less effective thermal performance.

One or more of the glass panes 12, 14, 16 can be low-e coated to reduce the radiation heat transfer through the window. Such coatings can inhibit the radiation heat transfer and improve the insulation of the window.

In the manufacturing process, separate glass panes 12, 14, 16 are placed in a vacuum chamber 36, and air is removed through a space 38 where the bonding fibers elements 28, 30 cross. Once the desired vacuum level is reached, the panes 12, 14, 16 are heated, thus melting the low temperature melting material 24 (but not the fibers 22), thereby creating an array of strong, hermetically sealed cells 34 once the glass panels 12, 14, 16 have cooled and the material 24 solidifies. The fibers 22 of the mesh structures 26 do not melt due to the fact that they are made from a high melting temperature material, but remain intact when the bonding element 24 melts. The fibers 22 act as a support structure holding the glass panes in the separated manner each from the other to prevent the glass panes from touching each other.

### Alternate Vacuum Insulated Glass Designs and Fabrication Methods

The sealed cells 34 of the subject TPVIG 10 can be of square, rectangular, diamond, or any other shape depending on the angle between the crossing bonding fibers 28, 30, as well as on the shape of the bonding fibers. The cells 34 in different embodiments can be hermetically sealed, partially sealed, or not sealed at all. If the cells 34 are not hermetically sealed, the TPVIG 10 is to be sealed at the edges of the panes as shown in FIG. 5. The edge seal 42 can be formed using, for example, either a solder glass or metallic seals. Flexible metallic seals could also be used as the edge seal 42 to reduce the stresses on the seal.

The bonding of the glass panes 12, 14, 16 can be accomplished in several ways. One of the ways assumes that a fiber 22 coated with the solder glass 24 is used to create the mesh structure 26, as well as the hermetic bonds. The elongated fiber 22 extends in conjunction with the elongated bonding elements 24. It is important that the bonding (sealing) elements 24 extend continually (with no voids therein) on the surface of the glass panes. A material used for the fiber in this embodiment may be glass, metal, ceramic, or any other material having a high melting temperature, for example, exceeding 500° C. The fiber 22 can be coated with a low melting temperature glass or metal 24 which melts at 250° C.-500° C.

The mesh structure 26 can be formed with a single material or a combination of two or more materials.

Alternatively, the mesh structure 26 can also be produced without a fiber core by extruding a low melting glass directly on the glass pane(s) using a variety of processes, such as 3-D screening, silk screening, etc., process. The glass panes 12, 14, 16 may also be held apart through some other mechanism during the heating process to control the pane spacing.

An alternative way to fabricate the mesh structure 26 may be through the use of a glass solder paste with a binder material that is evaporated during the heating process. The mesh structure 26 can also be metallic where the metal to glass bonds are used to bond the glass panes together.

The laying of the mesh structure 26 on the glass panes 12 and 14 may be achieved using a variety of processes, such as 3D printing, or screen printing.

Alternatively, the molten solder glass may be used as the mesh structure 26. Such molten solder glass may be laid on the fiber using the 3D printing process with a printer having one or more nozzles for dispensing the solder.

Although the mesh structure 26 provides the support needed to secure the adjacent glass panes 12, 14, 16 separate from each other, intermediate support structures, such as, for example, small pillars or small fibers may also be provided within the cells 34 themselves to act as additional spacer and support structures.

Stress analysis (detailed infra herein) of the subject TPVIG 10 manufactured by the subject method suggests that the maximum stresses occur at the spots where the bonding fibers 28, 30 from the two adjacent glass pane gaps cross each other. To reduce the stresses in glass panes, as well as in the fibers, the width of the seal line may be different at these crossing points.

The glass used in the subject TPVIG 10 may be soda lime, or tempered glass which can be thermally or chemically strengthened. The choice of the glass type depends upon the VIG design and intended application, as well as the strength requirements. In certain commercial applications, glass above a certain height from the ground is required to be fully tempered, whereas residential applications permit the use of annealed soda lime glass. Use of stronger glass may also result in lower overall thickness of the TPVIG 10.

In order to increase the insulation capability of the window, the VIG concept may also be used in combination of existing Insulated Glass Units (IGUs) by replacing one or both panes in an IGU with the TPVIG. This approach may be used in retrofit situations to keep the overall window thickness the same or similar to that of the existing window being replaced.

Referring to FIGS. 6A-6G, the exemplary subject manufacturing process is presented for production of the TPVIG 10 as a batch process in standard sizes, and the standard sized TPVIG structure 10 may be subsequently field cut to a required size. The subject process is applicable to production of TPVIG of any size. The standard size glass production is described herein only as an example. The spacing between the bonding fiber 21 in the mesh structure 26 can be adjusted for large orders of identical windows to minimize the uninsulated areas.

As shown in FIGS. 6A and 6B, a bottom glass pane 12 is manufactured, which is covered with a plurality 28, 30 of bonding fiber elements 21 in a mesh structure 26a. Each bonding fiber element 21, in this particular implementation of the subject method, includes a fiber core element 22 (˜75 μm, ˜600° C. melting temperature) layered on the surface of the bottom pane 12 in a predetermined pattern including the elongated elements 28, 30. The fiber core element 22 is coated with a low melting temperature (˜250-500° C.) frit 24 (˜50 μm thick coating) through, for example, an extrusion process (similar to coating an optic fiber with a polymer), or by drawing the fiber 22 through a molten bath of frit 24. The fiber 22 coated with the frit 24 represent the fiber/sealing bonding fiber (also referred to herein as element 21), as shown in FIGS. 4 and 6B.

As best shown in FIG. 6B, the fiber mesh structure 26a is configured on the bottom glass pane 12. The mesh structure 26a is formed by the fiber/sealing elements 21 extending in, for example, horizontal and vertical directions, thus forming elements 28 and 30, crossing each other at crossing points 39a. The distance between the fiber/sealing elements 21 may range between 40 mm to 80 mm in one direction and between 80 mm and 160 mm in another direction.

In an alternative embodiment, the mesh structure 26a may be formed aside from the subject process in a rolled format prefabricated and subsequently applied to the surface of the glass pane 12.

Subsequently, as shown in FIG. 6C, a second glass pane, i.e., the middle glass pane 14, is laid on the top of the mesh structure 26a formed on the surface of the bottom glass pane 12.

A second, preferably offset, layer of the mesh structure 26b is subsequently formed on the middle glass pane 14, as shown in FIG. 6D. The mesh structure 26b, similar to the mesh structure 26a, is formed by the bonding fiber elements 28, 30 crossing each other at the crossing points 39b, which may coincide vertically with the crossing points 39a, or be displaced therefrom to form offset mesh structures 26a and 26b. The mesh structure may be created in any of the manners described supra, similar to the mesh 26a.

Subsequently, as shown in FIG. 6E, a third glass plane, i.e., the top glass pane 16, is placed on the mesh structure 26b, thus completing the first triple-pane assembly 40. Short stacks of 2-3 TPVIG assemblies 40 are prepared in steps illustrated in FIGS. 6A-6E.

As shown in FIG. 6F, a stack 50 of the triple-pane assemblies 40 is placed in the vacuum chamber 36 with the heating elements 52 interspersed between them to efficiently heat the glass panes. The heating elements 52 may be in the form of an electrically heated plate, or a plate through which a high temperature heat transfer fluid flows (e.g., for example, Therminol 68, having a maximum working temperature of 360° C.).

The vacuum chamber 36 is subsequently closed, and a vacuum is created by removing air therefrom. When the vacuum chamber 36 is evacuated (for example, to approximately 10⁻³ Torr-10⁻⁴ Torr), the air leaves from the TPVIGs 40 through the spaces 38 existing at the crossing spots 39 where the bonding fiber elements 28, 30 overlap (as best shown in FIG. 6E). The total volume of air between the glass panes is only on the order of a few cm³.

The stack 50 shown in FIG. 6F is heated to a temperature ˜250° C.-500° C. to melt the frit coating 24.

When melting, the frit 24 fills the spaces 38, and, upon solidification, bonds the fibers 22 to the glass panes. The fibers 22 extending in crossing directions, are also bonded one to another at the crossing points, as shown in FIG. 6G. In addition, the frit 24 outlines and seals the cells 34 at their peripheries, as shown in FIG. 6G.

The fibers 22 do not melt, since they are compared of a high melting temperature material. The fibers 22 stay intact and create a support mechanism which supports the glass panes 12, 14, 16 separated one from another.

As shown in FIG. 6G, at the crossing points 39, the fibers 22 (vertical and horizontal) overlap one with another, and in combination, define the distance between the glass panes, i.e., twice the fiber diameter (˜150 μm) in the presented example.

As shown in FIG. 6G, multiple hermetically sealed cells 34 are created when the frit 24 solidifies upon cooling. The size of the cells 34 may be approximately 40 mm-80 mm×80 mm-160 mm. The cells 34 may hold the vacuum of 10⁻³-10⁻⁴ Torr. It is possible that the fibers 22 may fracture at the crossing points 39 due to high stress, but the fibers only act as spacers and do not affect frit created seals. The fiber diameter may need to be adjusted to produce a correct spacing if the fiber fracture occurs.

The contact point 39 of the crossing fiber/sealing elements 28, 30 becomes compressed due to the weight of the glass panes.

In one of alternative embodiments, instead of fibers coated with frit, a frit paste is silk screened onto a glass pane, and a fiber may be laid on the top. The process will be repeated for another pane that has the frit/fiber on both sides, as well as for a third pane with the frit/fiber on one side. The three panes will be aligned so the fibers extend in perpendicular (or angled at an angle other than 90°) to each other. This assembly will be placed in a vacuum chamber, a vacuum will be created, and subsequently the panes will be lowered onto each other. The assembly is heated to melt the frit and to create multiple sealed chambers 34 upon cooling and solidification of the frit.

Depending upon the VIG design, bonding (sealing) material, and the type of mesh structure, manufacturing methods may vary. One of the methods presented supra creates the separation between the glass panes, as well as their support in a required position, which is provided by the fiber mesh structure 26, due to the use of the solidified solder frit coated glass fibers as the mesh structure.

However, if the mesh structure is created in an alternative manner, such as, for example, with the use of the solder glass paste, as presented supra, an additional spacing mechanism may be needed to keep the panes 12, 14, 16 apart to create the vacuum between the glass panes. Similarly, once the vacuum is created, the glass panes spacing can be reduced further to ensure the proper contact with the solder material to control the gaps 18, 20 between the glass panes 12, 14, 16. Such spacing can be achieved using, for example, some mechanical mechanism, or using a solder glass, or other metallic preforms, which melt, or partially melt, as the fabrication process demands.

The mesh structure 26, in an alternative embodiment, can be prefabricated in rolls and can be spread between the glass sheets. The whole sheet of VIG is subsequently sealed in a vacuum furnace to produce the hermetically sealed grids in the glass.

The fiber mesh 26 may be visualized as a cloth fiber mesh spaced at large distances. Unlike the cloth fibers, the glass fibers, however, are incompressible, and, thus the overlapping point 39 of the crossing of the vertical and horizontal elements 28, 30 is two times thicker than the coated fiber 21. Thus, when the mesh structure 26 is embedded between the glass panes 12, 14, 16, the distance between the glass panes is two times the thickness of bonding fiber 21. This creates a gap between the fiber and the window panes everywhere except at the overlapping point of the fibers.

In another alternative embodiment, a middle pane with the mesh fibers can first be created under atmospheric conditions. This middle pane can be placed between the bottom and top panes, then the assembly can be placed in a vacuum chamber and heated to melt the frit to create multiple hermetic vacuum cells upon cooling.

Once the multiple panes and mesh stacks 40 are placed into the vacuum chamber 36, the vacuum is drawn form the chamber using, for example, a two stage vacuum system. The vacuum is created within the gaps 18, 20 between the glass panes due to the additional gap 38 between the fibers/sealing elements 21 and the glass panes 12, 14, 16. The total volume of the gaps between the panes is only of the order of few cubic inches. The vacuum chamber 36 is designed so that the vacuum creation between the glass panes is easier and cost effective.

Once the vacuum is created, the heat is applied to the vacuum chamber, causing the solder glass coating 24 on the glass fibers 22 to melt. This causes hermetic sealing between the fiber 22 and the window panes 12, 14, 16. Since the glass fiber's melting point is much higher than the solder glass coating, the glass fiber 22 remains intact and acts as a spacer material. In this semi-molten stage of the solder coating, the contact point 39 of the fibers is compressed more than the rest of the bonding fibers 21 due to the weight of the glass panes. The diameter of the glass fiber is chosen in such a way that when the coatings 24 melt, it fills the gap 38 created by overlapping fibers/sealing elements 28, 30.

The bonding stage of the subject process has been experimented to perfect the process. Glass soldering was studied for application in the subject process. Glass soldering is a widely used wafer bonding technique used in the encapsulation and creation of the vacuum tight sealing in micro machined structures. The bond thus created is hermetically sealed with high strength levels as the low melting intermediate glass layer molecules diffuse into the bonding surfaces, creating a high strength bond which is typically 20 MPa (or 2900 PSI) for a majority of the applications. Also, the bonding yield of the glass frit bonded wafer is very high. The wafer bonding typically uses screen printing process to create a uniform bonding. Although the process is well established, the suitability of the bonding process for the subject VIG application still must be established since it poses several challenges.

The grid-type sealing used in the subject structure is a line sealing instead of point contact (as in the case of the pillar spacers in a conventional VIG). This may be beneficial in several ways:

1) The force on the glass is distributed along this contact line as opposed to a single contact point, and hence the overall stress on the glass is reduced. Since the sealing between the glasses is distributed along the fiber joints, the stresses due to thermal expansion is also distributed over the glass pane rather than having the sealing only the periphery.

2) Another benefit of the bonding process used in the subject method is that the glass is divided into a plurality of vacuum sealed cells as opposed to a single large chamber between adjacent glass panes of the conventional VIGs. Thus, the glass can be cut into the desired pieces whenever needed for retrofit. This itself allows for mass production and reduces the manufacturing cost. When the glass is cut to a desired size, only a vacuum sealed cell (which is about 20 mm wide) which is cut loses the vacuum. The majority of the sealed cells 34 remain intact and, thus, hold the vacuum, and thus the overall glass does not lose the vacuum. If any of the internal seals fails, the glass is still vacuum tight, unless the failure is at the periphery. In that case, only the partial vacuum chambers lose vacuum. Similarly, if the window cracks, only a partial vacuum is lost.

The subject glass made with three or more glass panes has been chosen for a preferred embodiment to mitigate two issues: 1) to improve the thermal stress reliability of the glazing, and 2) to improve the thermal performance (or attain a low U factor).

The mesh structure is placed between the first two panes, and another mesh structure may be vertically placed between the 2^{nd} and 3^{rd} glass pane. However, the mesh structure positioning may be vertically staggered in such a way that the fibers do not overlap each other. For example, a fiber may be located at the center between two fibers of the mesh embedded in another gap. The staggered configuration creates a much longer path to conduct the heat, and hence improves the thermal performance of the window. The numerical thermal performance has shown that a U factor of 0.2-0.5 W/m²-K can be achieved using triple pane VIGs.

Although the uniform bonding of the fiber joints helps distribution of the stresses in the window, very high temperature difference between the inner and outer glass panes in a window are to be avoided as much as possible. Using three or more panes divides the temperature gradient into two or more parts. For example, in the case of three glass panes with two gaps between the glass panes, the temperature difference would be divided between the outer pane and the middle pane, as well as the middle pane and the inner pane. Thus, the temperature difference between any of the two adjacent panes in a three-pane embodiment becomes practically half of that in a two pane VIG. This reduces the thermal expansion mismatch between the two adjacent panes and thus improves the reliability of the joints significantly, making the subject TPVIGs suitable for cold climates where the temperature difference between indoor and outdoor is substantial.

The cost of the subject triple pane VIG does not exceed that of the double pane VIG. The manufacturing process of the subject VIGs is of a multistack type, i.e., the multiple stacks of the glass panes and bonding fiber (fiber/sealing) mesh structure therebetween are exposed to vacuumization, followed by heating, and subsequently are fused together. Fabricating the triple pane VIG does not add extra costs to the manufacturing cost for the double pane VIG.

Depending upon the strength of the glass, the pane thickness of the triple pane window can be reduced to about 2 mm instead of 3 mm used for the double pane window. Although the cost and weight of the subject 2 mm triple pane window glass is similar to that of the 3 mm double pane window, the strength, R value and reliability of the subject TPVIG is much better. In case of breakage, even if the vacuum in one layer of the vacuum sealed cells in the subject TPVIG fails, the second layer may still be active and provide a reasonably low U value. Similarly, several panes of the window can be manufactured for other commercial applications which require even higher thermal performance, without addition of significant costs to the window itself.

In order to achieve a high radiation resistance, the glass panes used in the subject TPVIG may be low-e glass coated. The low-e coating should withstand the heating temperatures used for the heating stage of the present fabrication process. As the bonding temperature used in the subject process is much lower than 500° C., and could be below 200° C., Pyrolytic low-e coatings are well suitable for this purpose. However, the emittance values are higher for such coatings.

Alternatively, soft low-e coatings with as low as 0.02 emittance values may be used in the manufacturing of the TPVIG. This may be possible because the bonding procedure may be performed in a vacuum environment and the chances of degradation of the e-coating during the heating are very minimal. The low-e coat may be applied, for example, to the inner surface of the innermost (indoor) pane and the indoor side of the middle pane.

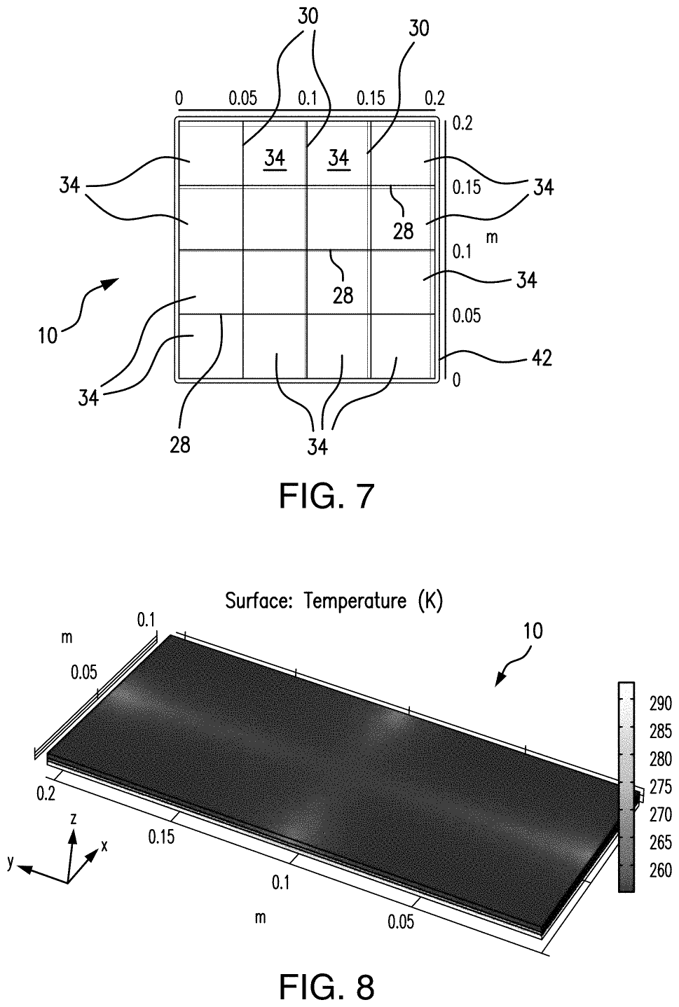

Numerical performance analysis of the subject TPVIG has been performed, and the results have been verified by the experimental analysis. A sample glass pane size of 400 mm width and 400 mm length was chosen for the modeling. This was achieved using a 200 mm×200 mm geometry, shown in FIG. 7 and using the symmetric boundary conditions on two of its sides.

The vacuum zone for the simulation was modeled as air with pressure of 10⁻⁴ Torr, and the inner (indoor) pane and the outer (outdoor) panes were subjected to the boundary conditions as recommended by National Fenestration Rating Council (NFRC). One face of the two out of the three panes (the innermost and the middle pane) were given an emissivity of 0.1 while the remaining faces had an emissivity of 0.84.

Regarding the analysis of the condensation performance, it was established that the minimum temperature at the center of the glass is equal to 279K or 6° C. (which is well above the dew point (3° C.) at standard indoor conditions) at the outdoor temperature of −18° C. The subject TPVIG thus is expected to have condensation below −20° C.

In certain embodiments, the bonding material of the fiber coating 24 can be melted and the glass fiber passed through the molten bonding material to create a uniform coating of the fiber. This process is similar to the coating of optical fibers. The thickness of coating depends upon the speed of fiber pulling through the molten matrix. In certain embodiments, the process of coating uses organic binders for coating the bonding materials. These bonding materials then can be burnt out at a predetermined temperature during the bonding process.

Fiber bonding and vacuum retention in the subject TPVIG has been tested. In the testing procedure, upon the successful coating of the fibers, the bonding fibers were used for bonding of the glass panes. During this process a smaller sample of the vacuum window glass was bonded in the vacuum environment. The hermetically sealed cells formed between the glass panes were tested for its vacuum retention. The vacuum retention procedure measured the vacuum level in the glass to ensure that the vacuum was maintained.

The samples also were tested for their strength and thermal performance. For example, a pressure test was applied to ensure the strength of the bonds.

In certain embodiments, the heating procedure inside the vacuum furnace involved heating of one or more glass panes. Detailed stress analysis for the full scale sample has been performed to establish the stresses in the glass and in the bonds. The stress analysis also helped in establishing an optimum spacing of the fibers in the TPVIG.

In certain embodiments, the uniform heating of the glass stacks and the bond creations, as well as the uniform suction of the vacuum, are key factors to the fabrication of the subject TPVIG. As such, the measurement of the vacuum propagation in the samples was used to determine the ability of the vacuum penetration through the gaps between the fibers and the glass panes before the creation of the bonding between the glass panes. When needed, the gap between the glass panes may be increased before the bonding to ensure the proper vacuum suction. Suitability of the various low e-glasses may be used for the VIG during this phase of the manufacturing process.

Manufacturing the VIGs can be completed in a variety of ways. Some examples include, but are not limited to: 1) produce the stack of VIGs in a batch process, and 2) incorporate the VIG production in the float glass production line similar to a vacuum sputtering process.

In certain embodiments, the size of the manufactured sample is the regular shipping size of the float glass. In certain embodiments, a stack of several VIGs glazing can be produced in a single batch using the vacuum furnace. The vacuum furnace used in such process will be much larger (e.g., 2 m×4 m), but the process of fabrication described supra remains the same.

The subject TPVIG process is much easier than the prior art processes in that it does not require majority of the routines needed for the IGU manufacturing. Also, it does not require use of inert gases and glue seals.

In certain embodiments, the subject process may be automated to avoid user related errors. Most of the operation, such as laying the full size glass panes and fiber mesh roll on the top of another in several layers, turning “on” the vacuum system, turning “on” the heat, and annealing of the VIGs may be automatic, making the fabrication of the TPVIG more cost effective.

Simulations of the conduction and radiation within a single pane, double pane, and the subject TPVIGs were performed using COMSOL™ for winter conditions specified in Table 1. Simulations results for specific cases are summarized in Table 2. The R-values presented are the ‘center of glass’ values for ease of comparison. The final values will depend upon the type of frame used. A single pane window has R=0.18 m²-K/W while the double pane IGU with low-e and argon insulation achieved R=0.62 m²-K/W. These results are consistent with simulations using DOE's Windows 7.4 software and were performed to validate the current simulations.

The TPVIG with 80 mm bonding fiber spacing, one low-e surface, and 2 mm glass achieved R=1.2 m²-K/W. However, TPVIGs with two surfaces with low-e coating achieved R=2.6 m²-K/W since the radiation from middle pane to outer pane is minimized, indicating the potential to achieve very high performance.

A full 3-D simulation has been performed. The temperature distribution on the outer surface for the TPVIG is shown on FIG. 8, which indicates the minimum temperature at the center of glass is 6° C. which is well above the dew point 3° C. for the NFRC specified winter conditions. The subject TPVIGs are expected to have condensation points below −20° C.

TABLE 1
NFRC winter weather conditions for the window simulation

| Thermal boundary | | |
|---|---|---|
| conditions | Value (SI) | Value (IP) |
| Interior ambient temperature | 21° C. | 70° F. |
| Exterior ambient temperature | −18° C. | −0.4° F. |
| Solar irradiation | 0.0 W/m² | 0 Btu/hr/ft² |
| Interior heat transfer coefficient | 3.1 W/m²-K | 0.55 Btu/hr/ft²-° F. |
| Outside heat transfer coefficient | 26 W/m²-K | 4.6 Btu/hr/ft²-° F. |

TABLE 2
Summary of performance simulations for various windows.
The emissivity of the low-e glass was assumed to be 0.02.

| CASE | Glass thk | Cavity | Glass thk | Cavity | Glass thk | Spacing | (ft²-hr-F./Btu) |
|---|---|---|---|---|---|---|---|
| 1. Single pane | 4 mm | | | | | | 0.2 |
| | (clear) | | | | | | |
| 2. Double pane IGU | 3 mm | Argon | 3 mm | | | | 0.533 |
| | (low-e) | (10 mm) | | | | | |
| 3. VIG (triple pane) | 2 mm | Vacuum | 2 mm | Vacuum | 2 mm | 80 mm | 1.2 |
| | (low-e) | (0.15 mm) | | | | | |
| 4. VIG (triple pane) | 2 mm | Vacuum | 2 mm | Vacuum | 2 mm | 80 mm | 2.6 |
| | (low-e) | (0.15 mm) | (low-e) | | | | |

Stress analysis of TPVIG was carried out using COMSOL Multiphysics 5.3 to understand the maximum stress occurring in TPVIG. The parameters varied in the study were the glass pane thicknesses, grid seal (frit) height and thickness, and the grid spacing in two perpendicular directions (which may be similar or different for the perpendicular directions).

Initial stress analysis simulation was validated using simple cases which have predefined analytic solutions for deformation and stresses. These cases were fix support beam case and a rectangular plate under pressure and fixed at the four sides. The results from the simulation matched with theoretical results. A grid independence study was also performed by refining the grid such that the minimum element size of the mesh was 1/10^{th} of the minimum feature size (frit dimension) in the TPVIG.

The initial analysis confirmed the feasibility of the subject concept, and proved that the supports provided by the fibers were adequate. The maximum deflection was 50 microns assuming the glass thickness of 3 mm and a Young's modulus of 72 GPa. The maximum stress in the glass was approximately 150 MPa for a 3 mm outer pane, 1 mm middle pane, and 3 mm inner pane TPVIG with 10 cm×10 cm mesh grid size. The maximum deflection in the glass were less than 50 micron. The stresses in the glass panes were usually in the order of 6-10 MPa except for the concentrated points at the fiber crossings of the adjacent pane gaps, where the local stresses could exceed 150 MPa. Since glass is a brittle material, the fracture mechanism may be much more complicated and unpredictable compared to the ductile materials.

In order to verify the strength of the glass, a sample TPVIG was built with similar dimensions and tested under vacuum. The test was repeated several times without failure of the glass.

Although this invention has been described in connection with specific forms and embodiments thereof, it will be appreciated that various modifications other than those discussed above may be resorted to without departing from the spirit or scope of the invention as defined in the appended claims. For example, functionally equivalent elements may be substituted for those specifically shown and described, certain features may be used independently of other features, and in certain cases, particular locations of elements, steps, or processes may be reversed or interposed, all without departing from the spirit or scope of the invention as defined in the appended claims.

What is claimed is:

1. A low-cost high-performance Vacuum Insulated Glass (VIG), comprising:
at least a first glass pane and at least a second glass pane stacked relative to said at least the first glass pane in spaced apart relationship therewith, thus defining a gap therebetween,
a first bonding mechanism disposed in said gap defined between said at least first and second glass panes, and
a first support mechanism disposed in said gap between said at least first and second glass panes,
wherein said first bonding mechanism includes at least a first plurality and at least a second plurality of elongated bonding elements extending in crossing relationship substantially continuously within said gap between said at least first and second glass panes, thus forming at least a first mesh structure embedded in said at least one gap and bonding said at least first and second glass panes together along said elongated bonding elements; and
a plurality of vacuum sealed cells defined between said at least first and second glass panes by said first mesh structure, each vacuum sealed cell being sealed along a periphery thereof by respective portions of said at least first and second elongated bonding elements crossing each other at respective crossing points.

2. The Vacuum Insulated Glass of claim 1, wherein said at least first mesh structure further includes said first support mechanism embedded in said gap, said first support mechanism including:
at least a first and a second plurality of elongated fiber elements arranged in substantial alignment with said at least first and second plurality of elongated bonding elements of said at least first mesh structure, said at least first and second plurality of elongated fiber elements extending in crossing disposition relative each to the other at said respective crossing points,
wherein said elongated fiber elements are bonded to said at least first and second glass panes and support said at least first and second glass panes at a predetermined spaced apart relationship.

3. The Vacuum Insulated Glass of claim 1, wherein said at least first and second glass panes include at least a bottom glass pane, a top glass pane, and a middle glass pane sandwiched between said bottom and top glass panes,
wherein said at least one gap includes a first gap defined between said bottom and middle glass panes, and a second gap defined between said middle and top glass panes,
wherein said at least first mesh structure includes a first mesh structure embedded in said first gap and securing said bottom and middle glass panes at a first predetermined distance one from another, and a second mesh structure embedded in said second gap and securing said middle and top glass panes at a second predetermined distance one from another.

4. The Vacuum Insulated Glass of claim 1, wherein said elongated bonding elements are formed from a material selected from a group including low temperature solder glass, low melting temperature glass, low melting temperature metal, frit, and combinations thereof, having a melting temperature within the approximate range of 250° C.-500° C.

5. The Vacuum Insulated Glass of claim 2, wherein said elongated fiber elements are made from a material selected from a group including a glass, metal, ceramic, and combination thereof, having a melting temperature exceeding approximately 500° C.

6. The Vacuum Insulated Glass of claim 1, wherein said glass panes are made from a material selected from a group including soda lime, tempered glass, thermally strengthened glass, chemically strengthened glass.

7. The Vacuum Insulated Glass of claim 3, wherein at least one surface of at least one of said bottom, middle and top glass panes is covered with a low emissivity material.

8. The Vacuum Insulated Glass of claim 2, wherein said elongated bonding elements and elongated fiber elements extend in alignment one with another, thus forming bonding fiber elements including a fiber core coated with a frit coating, wherein said diameter of said fiber core is approximately 75 μm, and wherein a thickness of said frit coating is approximately 50 μm.

9. The Vacuum Insulated Glass of claim 1, wherein said glass panes have substantially the same thickness ranging between 1.0 mm and 3.5 mm.

10. The Vacuum Insulated Glass of claim 1, wherein said glass panes have different thicknesses each from the other.

11. The Vacuum Insulated Glass of claim 3, wherein said first and second predetermined distances between said bottom and middle glass panes and between said middle and top glass panes, respectively, are approximately 0.15 mm, and are substantially the same, each of said first and second predetermined distances ranging between 0.1 mm and 0.15 mm.

12. The Vacuum Insulated Glass of claim 3, wherein said first predetermined distance between the bottom and middle glass panes differ from said second predetermined distance between the middle and top glass panes.

13. The Vacuum Insulated Glass of claim 1, wherein the size of each said vacuum sealed cell is within the range of 40 mm-80 mm×80 mm-160 mm.

14. The Vacuum Insulated Glass of claim 1, wherein said at least first plurality of the elongated bonding elements crosses said second plurality of the elongated bonding elements at a predetermined angular relationship ranging from approximately 30° to 120°, and wherein said vacuum sealed cells are contoured in a shape selected from the group of square contour, rectangular contour, triangular contour, rhombus contour, diamond contour, arcuated contour, wavy contour, and combinations thereof.

15. The Vacuum Insulated Glass of claim 1, wherein said vacuum sealed cells hold the vacuum of approximately 10⁻³ Torr-10⁻⁴ Torr.

16. The Vacuum Insulated Glass of claim 3, wherein said first and second mesh structures embedded in said first and second gaps, respectively, are aligned each to the other.

17. The Vacuum Insulated Glass of claim 3, wherein said first and second mesh structures embedded in said first and second gaps, respectively, are displaced from each other.

18. The Vacuum Insulated Glass of claim 2, wherein said predetermined spaced apart relationship between said at least first and second glass panes corresponds to combined diameters of said first and second elongated fiber elements overlapped each with the other at said respective crossing points,
wherein, at said crossing points, said at least first and second elongated fiber elements are bonded to said at least first and second glass panes, respectively.

19. A method for fabrication of low-cost high-performance Vacuum Insulated Glass (VIG), comprising:
(a) establishing at least a first, a second, and a third glass pane;
(b) applying a first mesh structure formed by at least a first and second plurality of elongated bonding elements extending substantially continuously on a surface of said first glass pane, said first and second pluralities of the elongated bonding elements crossing at first respective crossing points;
(c) positioning said second glass pane on said first mesh structure on said first glass pane in a first spaced apart relationship with said first glass pane;
(d) applying a second mesh structure formed by third and fourth pluralities of elongated bonding elements extending substantially continually on a surface of said second glass pane facing away from said first glass pane, said third and fourth elongated bonding elements crossing at second respective crossing points, wherein a relative disposition between said first and second mesh structures is selected from the group of aligned disposition, misaligned disposition, and combinations thereof; and
(e) positioning said third glass pane on said second mesh structure on said second glass pane in a second spaced apart relationship therewith, thus forming a stacked assembly of said first, second, and third glass panes with said first and second mesh structures therebetween;
(f) introducing said stacked assembly in a vacuum chamber;
(g) creating a vacuum in said vacuum chamber;
(h) heating said stacked assembly in said vacuum chamber to a predetermined temperature, thus melting said first, second, third and fourth elongated bonding elements of said first and second mesh structures, and thereby forming a first and second plurality of vacuum sealed cells, said first plurality of vacuum sealed cells being defined between said first and second glass panes, and said second plurality of vacuum sealed cells being defined between said second and third glass panes,
wherein each of said vacuum sealed cells is vacuum sealed along the periphery thereof by respective portions of respective of said first, second, third and fourth elongated bonding elements.

20. The method of claim 19, further comprising:
in said step (b), embedding a first support mechanism in said first gap between said first and second glass panes, and
in said step (d), embedding a second support mechanism in said second gap between said second and third glass panes;
wherein, in said step (h), said first and second support mechanisms secure said first, second, and third glass panes in a predetermined spaced apart relationship each to the other; and
wherein said first support mechanism includes a first and second plurality of elongated fiber elements arranged substantially in alignment with said elongated bonding elements of said first mesh structure, and
wherein said second separation mechanism includes a third and fourth plurality of elongated fiber elements arranged substantially in alignment with said elongated bonding elements of said second mesh structure.
